(19) United States
(12) Patent Application Publication
(10) Pub. No.: US 2026/0353141 A1
(43) Pub. Date: Nov. 5, 2026

(54) METHODS, ARCHITECTURES, APPARATUSES AND SYSTEMS FOR REPORTING SENSING MEASUREMENT INFORMATION VIA WIRELESS TRANSMIT/RECEIVE UNITS

(71) Applicant: InterDigital Patent Holdings, Inc., Wilmington, DE (US)

(72) Inventors: Kevin Wanuga, Souderton, PA (US); Fumihiro Hasegawa, Westmount (CA); Arman Shojaeifard, London (GB); Jongwoo Hong, New York, NY (US); Remun Koirala, London (GB); Paul Marinier, Brossard (CA); Moon IL Lee, Melville, NY (US); Ghyslain Pelletier, Montreal (CA)

(21) Appl. No.: 19/199,201

(22) Filed: May 5, 2025

(51) Int. Cl. H04W 24/10; H04L 5/00

(52) U.S. Cl. CPC H04W 24/10; H04L 5/0005

(57) ABSTRACT

Procedures, methods, architectures, apparatuses, systems, devices, and computer program products are provided for integrated sensing and communications. Wireless transmit/receive unit (WTRU) methods and systems include reporting sensing measurement values, used to perform one or more sensing services, to respective destinations based on sensing configuration information from a wireless network. The methods and systems further include receiving the sensing configuration information, performing sensing operations to generate sensing measurement values, determining at least one quality measurement value for each of the sensing measurement values, and identifying one or more destinations to report each of the sensing measurement values based on the respective at least one quality measurement value. The methods and systems additionally include that the at least one quality measurement value is associated with a respective one of the plurality of sensing services.

### TECHNICAL FIELD

The present disclosure is generally directed to the fields of communications, software and encoding/decoding, including, for example, to methods, architectures, apparatuses, systems related to reporting sensing measurement information from a wireless transmit/receive unit to the core network.

### BACKGROUND

Devices (e.g., wireless transmit/receive units) that are communicatively coupled to a wireless network may be configured by the wireless network to perform sensing operations and report to the wireless network. Conventionally, during this process, the wireless network does not adapt to sensing signal measurement quality degradation.

### SUMMARY

A wireless transmit/receive unit (WTRU) may be configured for integrated sensing and communication. For example, a WTRU (e.g., a sensing entity) may perform sensing operations for a number of sensing services based on receiving reference signals from the core network. However, a core network responsible for managing the sensing resources and aggregating the measurements from possibly multiple WTRUs may be unable to predict the quality of the sensing measurement values that is due to interference. Accordingly, systems and methods are desired for reporting sensing measurement information via WTRUs.

In accordance with certain embodiments of the present disclosure, methods and systems are provided for operating a WTRU. A method includes receiving, from a wireless network, sensing configuration information. The method also includes performing sensing operations to generate sensing measurement values for a plurality of sensing services. The method additionally includes determining at least one quality measurement value for each of the sensing measurement values, wherein each of the at least one quality measurement value is associated with a respective one of the plurality of sensing services. The method further includes identifying one or more destinations of a plurality of destinations to report each of the sensing measurement values based on the respective at least one quality measurement value. In some embodiments, the method also includes reporting each of the sensing measurement values to the respective one or more of the plurality of destinations, wherein the sensing measurement values are used by the one or more destinations at least in part to perform one or more sensing services of the plurality of sensing services.

In some embodiments, the plurality of sensing services may include any one or more of: asset tracking, asset localization, intruder detection, roadside monitoring object detection, unmanned aerial vehicles (UAV) collision avoidance, automotive maneuvering and navigation, rainfall monitoring, public safety search and rescue, and health and sports monitoring. In some embodiments, the plurality of destinations is associated with a respective one or more sensing services of the plurality of sensing services and identifying the one or more destinations includes identifying the one or more respective sensing services for each of the plurality of destinations, comparing the respective at least one quality measurement associated with each of the plurality of sensing services to respective thresholds, and based on the comparing, identifying the one or more destinations. In some embodiments, the sensing configuration information includes at least a sensing measurement configuration and a quality measurement configuration. In some embodiments, the at least one quality measurement includes at least one explicit (e.g., direct) quality measurement or at least one implicit (e.g., indirect) quality measurement.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram depicting an example of multiple sensing services deployed within the coverage region of a wireless network, in accordance with certain embodiments;

FIG. 3 is an illustrative signal flow diagram of WTRU timing and quality signals, in accordance with certain embodiments; and

FIG. 4 is a flowchart of an illustrative method performed by a WTRU for reporting sensing measurement values based on WTRU quality measurements, in accordance with certain embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

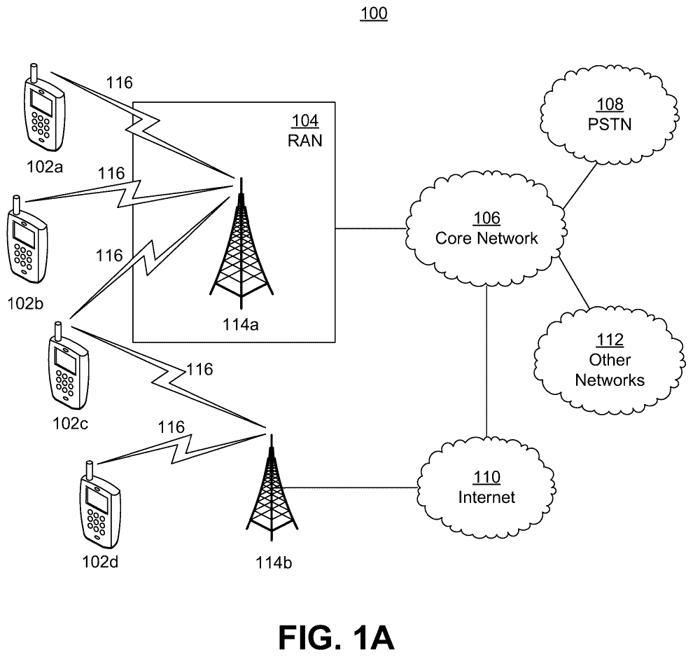

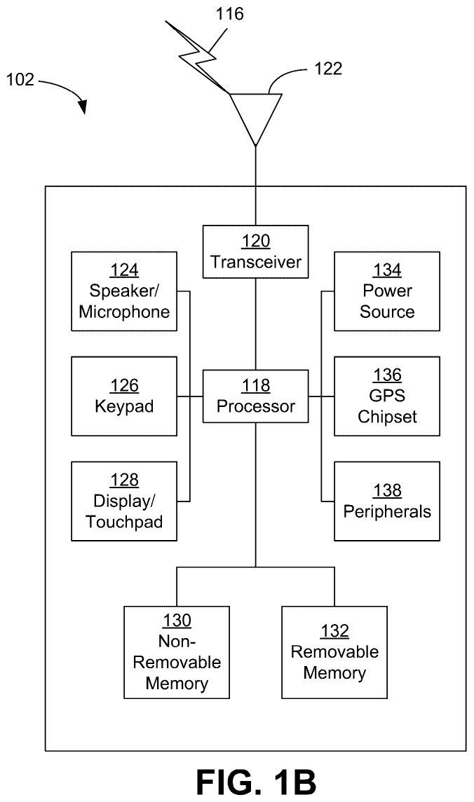

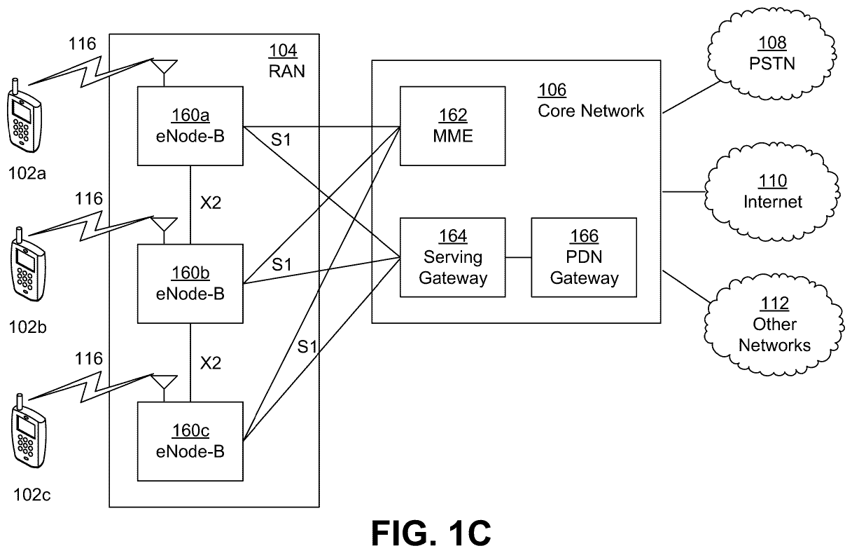

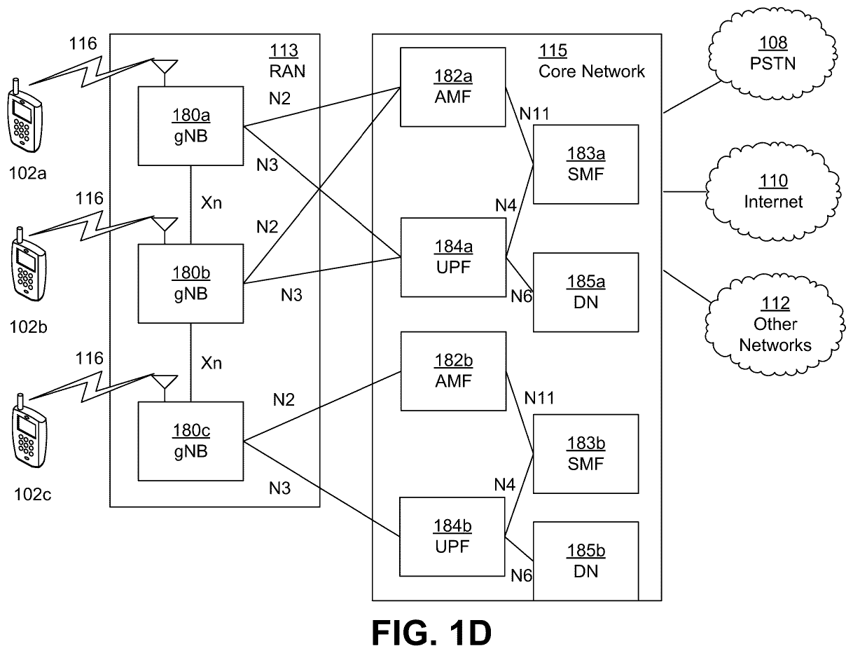

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNB, a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

It will be understood that a wireless network may include any suitable components and devices, including, for example, any of one or more base stations, one or more TRPs, one or more gNBs, one or more WTRUs, any network functions, one or more RANs, one or more application functions, one or more access and mobility management functions (AMFs), any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

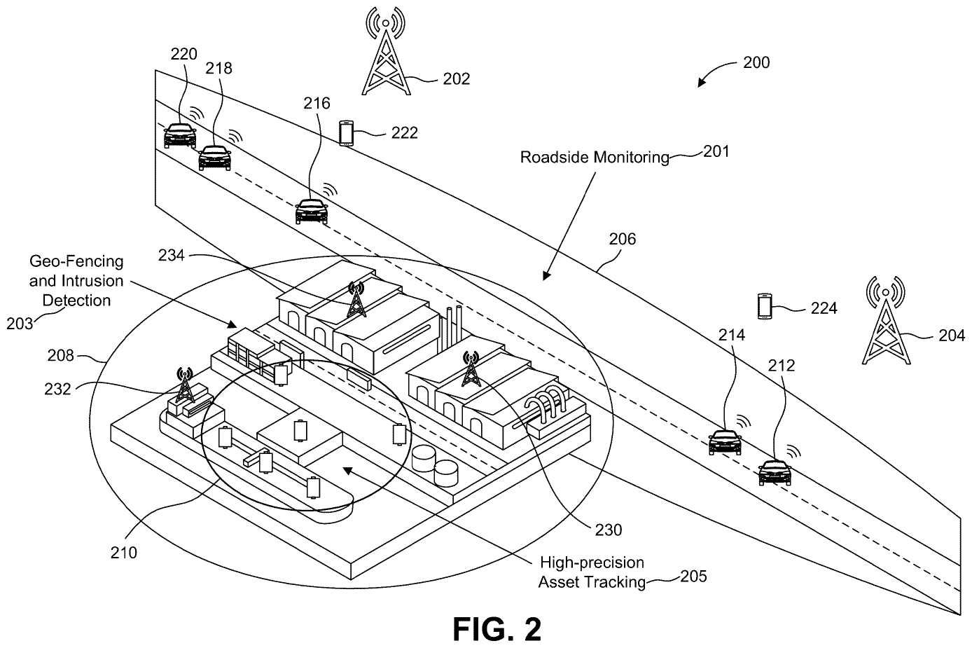

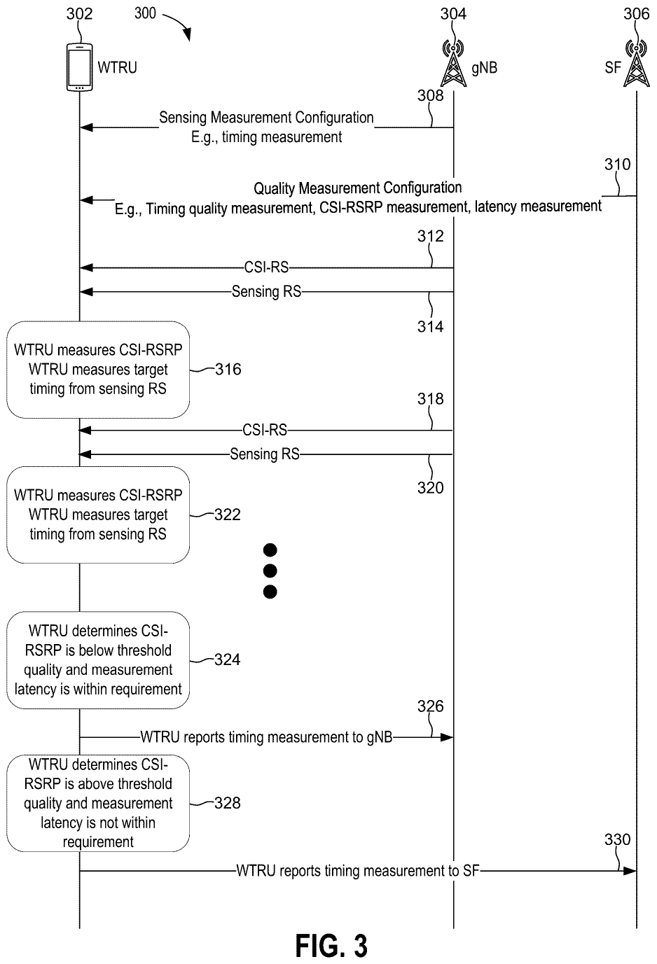

In certain embodiments of the present disclosure, including those described below at least in connection with FIGS. 2-3, the devices, systems, architectures, communication links, apparatuses, and other elements depicted in FIGS. 1A-1D may be used in connection with reporting sensing measurement information via WTRUs.

For example, in connection with reporting sensing measurement information via WTRUs, configuration for a network QoS framework may be described as follows. QoS for wireless network sensing services may be determined for an end user who is not necessarily a WTRU within the sensing service region. For example, the sensing QoS may be provided to an end user via exposure of sensing measurement data from the core network (e.g., to a web API). In some embodiments, in order to meet QoS requirements, the core network management framework for sensing may require the core network to aggregate individual measurements from multiple WTRUs within a sensing service region to estimate the sensing QoS. In this regard, WTRU link quality changes (e.g., both dynamic and slow-varying) may impact the aggregate service-level quality for sensing with a sensing service region. Thus, the wireless network QoS framework may provide configurations to adapt WTRUs sensing measurement value reporting to improve spectral efficiency for sensing measurement values and reduce sensing service latency.

For example, in connection with reporting sensing measurement information via WTRUs, configuration for downlink reference signals (DL-RS) may be described as follows. In one example, a DL-RS configuration may contain at least one of the following parameters: number of symbols, transmission power, number of DL-RS resources included in DL-RS resource set, muting pattern for DL-RS (e.g., the muting pattern may be expressed via a bitmap), periodicity, type of DL-RS (e.g., periodic, semi-persistent, or aperiodic), slot offset for periodic transmission for DL-RS, vertical shift of DL-RS pattern in the frequency domain, time gap during repetition, repetition factor, resource element (RE) offset, comb pattern, comb size, spatial relation (e.g., with respect to other DL-RSs or UL RS such as SRS for positioning purpose), quasi co-location (QCL) information (e.g., QCL target, QCL source) for DL-RS, number of TRPs, absolute radio-frequency channel number (ARFCN), subcarrier spacing, expected reference signal time difference (RSTD), uncertainty in expected RSTD, start physical resource block (PRB), bandwidth, bandwidth part (BWP) identifier, number of frequency layers, start/end time for DL-RS transmission, on/off indicator for DL-RS, TRP identifier, DL-RS identifier, cell identifier, global cell identifier and applicable time window. The WTRU may apply a DL-RS configuration under a condition that the current time is within the applicable time window. It should be noted that the term “identifier” may be used interchangeably with “index”.

For example, in connection with reporting sensing measurement information via WTRUs, general behavior for WTRUs may be described as follows.

In certain representative embodiments, the WTRU may send a request to the core network for one or more configuration (e.g., DL-RS configurations, UL-RS configurations) via a physical uplink shared channel (PUSCH), physical uplink control channel (PUCCH), uplink control information (UCI), medium access control-control element (MAC-CE), radio resource control (RRC) or LTE Positioning Protocol (LPP) message. The WTRU request may include configurations of a measurement gap, DL-RS processing window or window for transmission of UL-RS.

In some embodiments, the WTRU may send an acknowledgement message in PUSCH or PUCCH for the grant received from the core network.

In certain representative embodiments, the WTRU may be configured with one or more conditions or criteria corresponding to a WTRU behavior, in which the WTRU may determine which behavior the WTRU may use based on the applicable condition or criteria.

In some embodiments, a WTRU may measure DL-RS and/or may transmit UL-RS inside or outside of an active BWP.

In some embodiments, the WTRU may be preconfigured with parameters (e.g., measurement gaps, DL-RS processing windows, DL-RS configurations, UL-RS configurations) via a semi-static message (e.g., LPP, RRC).

In certain representative embodiments, the WTRU may be configured by the core network for any actions the WTRU determines to perform. For example, the WTRU may be configured with a rule and, according to the rule, the WTRU may determine to take an associated action.

In some embodiments, in addition to the measurements made on DL-RS, the WTRU may perform one or more cell-related measurements. For example, the WTRU may measure SSB RSRP from the serving cell with corresponding cell identifier, SSB RSRP from the neighboring cell(s) with corresponding cell identifier(s), RSRP of CSI-RS with CSI-RS resource identifier, and/or RSRP of DM-RS.

In this disclosure, the terminology may be described as follows.

The term “network” may correspond to a function, node, and/or a protocol that terminates in the radio access (e.g., gNB, NG-RAN) entity or in the core network (e.g., access & mobility management function (AMF), location management function (LMF), data collection function or similar). The terms “pre-configuration” and “configuration” may be used interchangeably. The terms “non-serving gNB” and “neighboring gNB” may be used interchangeably. The terms “gNB” and “TRP” may be used interchangeably. The terms “DL-RS” or “DL-RS resource” may be used interchangeably. The terms “DL-RS(s)” or “DL-RS resource(s)” may be used interchangeably. The aforementioned “DL-RS(s)” or “DL-RS resource(s)” may belong to different DL-RS resource sets. The terms “measurement gap” or “measurement gap pattern” may be used interchangeably. “Measurement gap pattern” may include parameters such as measurement gap duration or measurement gap repetition period or measurement gap periodicity. The term “parent gNB” may refer to the serving gNB in some examples.

An LMF is a non-limiting example of a node or entity (e.g., network node or entity) that may be used for or to support positioning or sensing. Any other node or entity may be substituted for LMF and still be consistent with this disclosure.

The WTRU may receive a preconfigured threshold(s) from the wireless network (e.g., LMF, gNB).

The line-of-sight (LOS) indicator may be a hard (e.g., 1 or 0) or a soft indicator (e.g., 0, 0.1, 0.2 . . . , 1) and the LOS indicator indicates likelihood of the presence of an LOS path between TRP and WTRU or along DL-RS. The LOS indicator can be associated with a TRP or PRS resource identifier (e.g., index). The WTRU may receive the LOS indicator from the wireless network per TRP or resource identifier. Alternatively, the WTRU may determine the LOS indicator per TRP, or resource identifier based on measurements.

A WTRU location may be expressed, for example, in terms of altitude, latitude, geographic coordinate, or local coordinate.

In the examples described herein, a timestamp may be indicated by absolute time, relative time (e.g., in seconds) compared to a reference time, system frame number (SFN), slot index, frame index, subframe index, and/or symbol index. For example, an absolute time may be UTC time, GNSS time, locally defined absolute time (e.g., LTE or NR Time).

In the examples described herein, the WTRU may receive configurations for a time window such as duration (e.g., expressed in terms of seconds, number of symbols, number of slots, number of frames, number of subframes), start and/or end time (e.g., expressed in terms of absolute time, system time, relative time with respect to a reference time indicated by the wireless network or determined by the WTRU, SNF index, slot index, symbol index, frame index, subframe index). The WTRU may receive one or more configurations of a time window where each configuration is associated with an index. The wireless network may send a trigger to initiate the time window. For example, the WTRU may receive a command (e.g., downlink control information (DCI)) to initiate an indicated time window, which has been indicated via the configuration index. The WTRU may determine to initiate the time window after a configured duration after reception of the command (e.g., N symbols, N slots, N frames, N seconds). The WTRU may receive, from the wireless network, an activation or deactivation command (e.g., DCI, MAC-CE) to activate or deactivate the time window.

FIG. 2 is a diagram 200 depicting an example of multiple sensing services deployed within the coverage region of a wireless network, in accordance with certain embodiments.

In accordance with certain embodiments of this disclosure, a reference model of a wireless network, is shown in FIG. 2 and described as follows. FIG. 2 illustrates an example of multiple sensing services, for example, roadside monitoring 201, geofencing and intrusion detection 203, and high precision asset tracking 205, within a coverage region. The sensing services may be provided by TRPs 202, 204, 230, 232, and 234. In certain representative embodiments, the sensing services provided by the core network may not be provided to all WTRUs connected to the core network. For example, the sensing service may use mobile WTRUs (e.g., WTRUs 102a-d of FIG. 1, WTRUs 212, 214, 216, 218, 220, 222 or 224 of FIG. 2, or any other suitable mobile WTRU, or any combination thereof) on the network to perform sensing measurements and a sensing function (SF) within the core network architecture may aggregate and provide the sensing measurement data to an end user, as required (e.g., via a web API). In some approaches, sensing services may be configured in different partially or completely overlapping regions within the core network coverage area. For example, corresponding performance and/or quality requirements of the sensing services may be configured in each of regions 206, 208, and 210. In some embodiments, the WTRUs may receive sensing configuration information to identify one or more destinations for the sensing measurement values based on at least one quality measurement value.

In some embodiments, the WTRUs that receive routine mobile coverage within the core network may support the sensing services. For example, WTRUs 222 and 224 may provide sensing measurement values to the core network. The sensing measurement provided by WTRU may be impacted, e.g., by poor coverage and/or increased interference, resulting in dynamic changes to the sensing services based on the changing coverage conditions of the supporting WTRUs. Accordingly, the SF, which may be responsible for sensing quality at the service level, may depend on WTRU reports of sensing signal measurement quality estimates to make informed decisions about how sensing measurements should be configured. For example, the SF may determine sensing measurement configuration based on slow-varying factors and/or rapid-varying factors that may impact sensing signal measurement quality.

The slow-varying factors may include the power of receive sensing reference signals (RS) and/or device impairments. For example, the power of receive sensing reference signals may be determined by the pathloss and LOS conditions that exist between the sensing transmitter (STx) and target, the target and the sensing receiver (SRx) and the STx and SRx. The power of receive sensing reference signals may be expected to vary with changes in STx, SRx, or target mobility. In another example, device impairment may be determined by observed signal noise that may depend on device hardware implementation and may change with changes in device or environment temperature (e.g. thermal noise).

The rapid-varying factors may include interference and/or available network resources. For example, the periodic transmissions of nearby TRPs and WTRUs within the sensing service area (e.g., regions 206, 208, and 210) may produce unwanted interference to the SRx. Interference may change with either SRx, or WTRU mobility or with changes in mobile traffic. In another example, network resources for sensing measurements may be shared, for example, with devices supporting communication services, and the resource availability may change subject to changes in congestion and traffic patterns within a cell overlapping the sensing service area (e.g. based on prioritization of traffic over sensing RS). Accordingly, sensing measurements may be configured with reference signals of varying bandwidths and time domain resources to determine available resources.

In some embodiments, a framework is provided for monitoring the quality of sensing signal measurements.

In certain representative embodiments, location services (LCS) manage QoS for positioning measurements. As an example, a 3GPP framework may include requirements on horizontal and vertical accuracy for positioning estimates, and latency requirements on response time. Additionally, the wireless network framework may define the LCS QoS classification that describes the expectation on WTRU reporting behavior with regard to QoS requirements. For example, the QoS requirements may include best effort class, multiple QoS class, and assured class. For example, in best effort class, the WTRU should still report positioning measurement even if other QoS requirements are not fulfilled. For example, in multiple QoS Class intermediate requirements are defined which, if not fulfilled, may trigger additional measurements from the LMF. For example, in assured class, all measurements that do not fulfill QoS requirements are discarded. In s wireless network framework, QoS requirements are configured for the WTRU as the end user of the positioning service, similar to communication services.

In certain representative embodiments, a network framework may be enabled to adapt to sensing signal measurement quality degradation of multiple WTRUs. For example, the wireless network (e.g., base station, sensing function) may provide configurations to WTRUs to manage the sensing resources and aggregate the measurements from the WTRUs for the same target device. The framework may rely on WTRUs to determine the quality of the received sensing signal. For example, the quality may vary based on the interference and the interference may not be predictable by the wireless network due to, for example, WTRU geographical location, base station scheduling strategies.

FIG. 3 is an illustrative signal flow diagram of WTRU timing and quality signals, in accordance with certain embodiments. In some embodiments, the WTRU may report sensing measurement values to different reporting destinations (e.g., parent gNB, SF within the core network) in support of different sensing services based on configured WTRU-specific sensing performance requirements. As shown in FIG. 3, in certain representative embodiments, WTRU 302, in connection with gNB 304 and SF 206, performs sensing operations to generate sensing measurement values and determine quality measurement values. WTRU 302 may report the sensing measurement values to gNB 304 and/or SF 206 based on received configurations from the wireless network. In this regard, WTRU 302 may adaptively support multiple sensing services with a single sensing measurement value based on WTRU 302 estimating the quality of the sensing measurement performed. Additionally, WTRU 302 link monitoring measurements may reduce the signaling overhead and lower the signal latency for network QoS management of multiple sensing services, for example, as compared to the SF function performing all sensing measurement and reporting decisions based on aggregated measurement data.

In certain representative embodiments, WTRU 302 may receive from the wireless network (e.g., gNB 304, SF 306, or any other suitable ISAC framework component) sensing configuration information. For example, WTRU 302 may be configured by the wireless network to generate one or more sensing measurement values. For instance, WTRU 302 may be configured to estimate the delay of an RS reflecting off a target relative to the same RS transmitted directly from the STx to the SRx. WTRU 302 may also be configured by the wireless network to determine one or more quality measurements associated with each configured sensing measurement. For instance, WTRU 302 may be configured to measure the range of delay estimates for a configured timing measurement that accounts for an amount (e.g., 95%) of possible delay estimates for the given target. In another example, WTRU 302 may be configured by the wireless network to have at least two quality requirement conditions (e.g., thresholds, parameters, or any other suitable requirement conditions, or any combination thereof) for a quality measurement, in which each quality requirement condition is associated with a different sensing service that may require reporting measurements to a different destination (e.g., gNB 304, SF 306, or any other suitable destination, or any combination thereof). For instance, where there are two different destinations associated with two sensing services, WTRU 302 may, based on the configured quality requirement conditions, report the sensing measurement to one destination (e.g., when one requirement is met), both destinations (e.g., when both requirements are met), or neither of the two different destinations (e.g., when no requirement is met).

For example, at step 308, gNB 304 may transmit sensing configuration information to WTRU 302. The sensing configuration information may include one or more sensing resource configurations and sensing measurements configurations. For example, the sensing configuration information may include a sensing measurement identifier (e.g., an identifier for the measurement configured by the parent gNB), time and frequency resources for the sensing measurement, a periodicity for the sensing measurement, an RS configuration, and/or a sensing measurement configuration (e.g., including measurement type, measurement quantity, and measurement filtering configuration). For the purpose of description, a WTRU that is configured to measure sensing reference signals and report sensing measurement values to the core network is referred to as a sensing Rx (SRx).

In some embodiments, the time and frequency resources for the sensing measurement may include time domain resources and frequency domain resources. For example, time domain resources may include an indication to a slot within a subframe, a symbol within a slot and a duration in symbols, and/or an indication to a symbol within a mini-slot configuration. For example, frequency domain resources may include an indication to a starting common resource block (CRB) or subcarrier within a CRB and a bandwidth in CRBs or subcarriers, and/or an indication to a resource block (RB) or a subcarrier within the RB within a BWP configured for the WTRU and a bandwidth in CRBs or subcarriers within the BWP.

In some embodiments, the periodicity for the sensing measurement may include an indication to a period in the number of frames or subframes and an offset in the frames or subframes within the indicated period.

In some embodiments, the RS configuration may indicate the modulated symbol mapping to each time and frequency resource within the time and frequency resource configuration for the sensing measurement. For example, the RS configuration may include a procedure for generating the modulated symbols. For instance, the RS configuration may use a generator function (e.g. a sequence generator polynomial for generating gold sequences, m-sequences, Zadoff-Chu sequences, or any other suitable generator function, or any combination thereof) for creating the modulation symbols is to be mapped to resources. The generator function may include initial conditions, for example, parameters for generator functions or initial register states for state machines used in sequence generation. The RS configuration may also include initial conditions and parameters for a pre-defined or specified sequence generation rule, (e.g. pseudo-random sequence, low PAPR sequence type 1 or 2, NZP-CSI-RS, or any other suitable sequence generation rule, or any combination thereof), and/or may include an indicator to an RS configured for the WTRU 302 for other purposes (e.g., NZP-CSI-Resources identifier, synchronization signal block (SSB) identifier, or any other suitable indicator, or any combination thereof).

In some embodiments, the measurement configuration may include a sensing measurement type, a sensing measurement quantity, and/or a sensing measurement filtering configuration (e.g., a number of measurements to filter, filtering rules for measurements, or any other suitable filtering configuration, or any combination thereof). As a non-limiting example, the measurement configuration may include a timing measurement, a phase measurement, an angular measurement, a power measurement, and/or a detection measurement. These measurements are discussed in further detail below.

In certain representative embodiments, WTRU 302 may receive from the core network (e.g., gNB 304, SF 306, or any other suitable ISAC framework component) one or more quality measurement configurations for sensing quality measurements that WTRU 302 may measure and/or calculate to estimate the quality of any configured sensing measurement.

For example, at step 310, SF 306 may transmit a quality measurement configuration to WTRU 302. As a non-limiting example, the quality measurement configuration may include a quality measurement identifier (e.g., an identifier for the quality measurement configured by the parent gNB), an associated sensing measurement identifier, a periodicity for determining the quality measurement, a quality measurement type of the quality measurement, and/or a quality measurement quantity for the quality measurement.

In some embodiments, the associated sensing measurement identifier may include, for example, an indication of the one or more sensing measurements that have been configured by the wireless network (e.g., at step 308), an indication of associated measurement types (e.g., timing measurements, phase measurements, angle measurements, or any other suitable measurement types, or any combination thereof), and/or an indication to a higher-layer NAS indicator of service identifier. In some embodiments, the periodicity for determining the quality measurement may include, for example, an indication to a period in the number of frames or subframes and an offset in the frames or subframes within the indicated period. In another example, the periodicity may be configured as a multiple of the configured periodicity for the associated sensing measurement (e.g., quality measurements are performed on every N^{th} sensing measurement). In some embodiments, the quality measurement type may include, for example, implicit and/or explicit measurement types, discussed in more detail below. In some embodiments, quality measurement quantity may include the different methods in which a measurement type is calculated and/or reported (e.g., the estimated standard deviation of the sensing measurement report, or an X % confidence interval for the measurement report, or any other suitable method in which a measurement type is calculated and/or reported, or any combination thereof).

In some embodiments, at steps 312 and 314, gNB 304 transmits CSI-RS and sensing RS, respectively. Steps 312 and 314 many occur substantially simultaneously.

In some embodiments, at step 316, WTRU 302 may measure the received CSI-RSRP and measure the target timing from the receives sensing RS.

In accordance with certain embodiments of the present disclosure, WTRU 302 quality measurements of process 300 are described as follows.

WTRU 302 may utilize explicit or direct quality measurements as estimates of the quality of the sensing signal measurement that can be determined from the configured sensing signal measurement (e.g.: delay/timing, angle, or any other suitable sensing signal measurement, or any combination thereof) directly. For instance, WTRU 302 may estimate the quality of a timing measurement by using a correlator output to perform a timing measurement and report the maximum likelihood delay from the correlator output associated with the target under a set of modeling assumptions. WTRU 302 may employ modeling assumptions, for example, assuming a statistical model for the delay samples captured, a time window over which captured measurements could be considered stationary, and/or truncation dropping rules for out-of-range samples. WTRU 302 may may also estimate the timing measurement quality by measuring the range of correlator delay outputs that correspond to a percentile (e.g., 95th percentile) of the target delay.

As a non-limiting example, WTRU explicit quality measurement configurations may include computing (e.g., via model and/or function assumptions) a measurement quality from the sensing measurement, measuring the quality according to a quality measurement type (e.g., timing measurement quality, phase measurement quality, angular measurement quality, power measurement quality, detection measurement quality, any other suitable quality measurement, or any combination thereof), determining a ratio of valid measurements to invalid measurements, and/or determining a time required to collect a valid quality measurement.

In some embodiments, the measurement quality computation may include, for example, an assumed statistical model for collecting measurements (e.g., exponentially distribution delay, uniformly distribution angle of arrival (AoA) or angle of departure (AoD), any other suitable statistical model, or any combination thereof), one or more timing windows for which a set of samples may be included in quality measurements (e.g., a window over which measurements may be assumed to follow the same statistical model), one or more rules for determining if samples are valid or invalid including valid ranges of measurements, one or more rules on discarding out of range or invalid measurements, and/or a minimum number of valid measurements to compute valid quality measurement.

In some embodiments, the timing measurement quality may include, for example, a range (e.g., minimum and maximum value, or lower and upper bound) of delay estimates from a timing measurement, and/or a resolution of measurements (e.g., resolution of timing measurements expressed in terms of nanoseconds). For example, WTRU 302 may be configured with a range of delay estimates from a timing measurement that may constitute a percentage likelihood (e.g., 90%) of all delay estimates from the given timing measurement, where the percentage likelihood may be configured by the wireless network. In another example, WTRU 302 may be configured with the minimum timing resolution quality, in which, upon determination that the timing resolution is not achieved, WTRU 302 may report to the wireless network that measurements could not be performed according to the required resolution.

In some embodiments, phase measurement quality may include, for example, a range of phase estimates from a phase measurement that constitute a percentage likelihood (e.g., 90%) of all phase estimates from the given phase measurement, where the percentage likelihood may be configured by the wireless network. In some embodiments, angular measurement quality may include, for example, range of angle estimates from an angular measurement that constitute a percentage likelihood (e.g., 90%) of all angular estimates from the given angle measurement where the percentage likelihood may be configured by the wireless network. In some embodiments, power measurement quality may include, for example, a variance of the measured power from the RS. In some embodiments, detection measurement quality may include, for example, an estimated probability of missed detection or false alarm from a detection measurement decision.

For example, implicit or indirect quality measurement may be from measurements other than the sensing signal measurement directly. For the quality measurement, for example, WTRU 302 may use the signal quality of the sensing measurement as a proxy, measure interference of an RS, or use radio link quality metrics as a proxy. In some embodiments, implicit or indirect quality measurements may include, for example, an associated radio link monitoring (RLM) measurement, an associated CSI-IM measurement, a measurement validity window (e.g., the maximum amount of time allowed to elapse between a sensing measurement and the associated quality measurement used to estimate its quality), link quality requirements, hysteresis rules for quality measurements, and/or filtering rules for quality measurements. For example, associated RLM measurements may include CSI-RSRP, CSI-RSRQ, SSB-RSRP, SSB-RSRQ. For example, WTRU 302 may determine measurement quality based on a CSI-RSRP, a CSI-RSRQ, an SSB-RSRP and/or an SSB-RSRQ measurement that is QCL with the sensing measurement indicated by the gNB or SF. In another example, WTRU 302 may determine quality based on a CSI-IM measurement indicated by the gNB or SF that is QCL with the sensing measurement indicated by parent gNB. For example, link quality requirements may include the range of measured values (e.g., associated RLM or CSI-IM measurement quantities) that indicate quality requirements are sufficient and/or insufficient. As an example of hysteresis rules, WTRU 302 may be configured to observe N successive sufficient or insufficient quality measurements before determining that the sensing measurement quality is sufficient or insufficient, respectively. As an example of filtering rules, WTRU 302 may be configured to determine sensing measurement quality as a function of current and past associated quality measurements as indicated by the parent gNB.

In some embodiments, WTRU 302 may use a measurement of the sensing signal (e.g., not the sensing signal measurement directly) as the signal quality of the sensing measurement. For example, the signal-to-noise ratio (SNR) or signal-to-interference-noise ratio (SINR) measurements of the sensing signal are indirect measurements from which WTRU 302 may infer the quality of the sensing signal measurement. For instance, WTRU 302 may correlate a very low sensing signal SINR with a sensing signal measurement of low quality. In another example, WTRU 302 may be configured to measure and report the sensing signal SNR or SINR directly. In another approach, WTRU 302 may be configured to measure the sensing signal interference separately, for example, by way of using zero-power signals. More specifically, WTRU 302 may be configured with zero-power sensing reference signals (ZP-Sens-RS) over specified time/frequency resources. A WTRU configured to use the signal quality of the sensing measurement as a proxy for the quality measurement may be easier to implement and validate for interoperability purposes given that the measurement is taken directly from the sensing measurement.

In some embodiments, WTRU 302 may be configured to make measurements on interference on the received DL-RS for sensing. For example, WTRU 302 may be configured to measure the power of the DL-RS and/or to estimate and report SNR or SINR. In another example, WTRU 302 may be configured with DL-RSs to make measurements on the SNR or SINR. The DL-RSs may include, for example, CSI-ZP (zero power), or DL-RS time and/or frequency resources during which no signals or channels are transmitted from the wireless network. WTRU 302 may use such resources to measure if there are any interference.

In some embodiments, WTRU 302 may be configured to measure the indicated type of measurements for the interference measurements (e.g., timing, power, phase).

In some embodiments, WTRU 302 may be configured with conditions to measure and/or report interference measurements. For example, WTRU 302 may be configured with periodic resources (e.g., CSI-ZP) for interference measurements and/or thresholds for measurements (e.g., reference signal received power (RSRP) threshold). For instance, WTRU 302 may be configured to measure interference of the configured resources upon determining that the RSRP of the DL-RS (e.g., CSI-RS) is below a threshold. WTRU 302 may report the measurements related to interference to the wireless network. In this regard, the configured DL-RS may be used for sensing purposes.

In some embodiments, WTRU 302 may be configured to determine a reporting destination (e.g., gNB, SF, or any other TRP, or any combination thereof) for the interference measurements based on the quality of interference measurements. For example, WTRU 302 may be configured such that, upon determining that the interference measurement is above a configured threshold (e.g., WTRU 302 measures considerable interference), WTRU 302 may determine to report the interference measurement to the gNB. In another example, WTRU 302 may be configured such that, upon determining that the interference measurement is below a configured threshold WTRU 302 may determine to perform at least one of reporting the default measurement (e.g., RSRP for CSI-RS) to the gNB, reporting the configured measurement to SF (e.g., measurement for DL-RS for sensing), not reporting the measurements (e.g., RSRP, sensing measurements, etc.) to the gNB or SF.

In some embodiments, WTRU 302 may use radio link quality metrics used for Uu (e.g., air interface 116 of FIG. 1., or any other suitable air interface between a WTRU and a eNB/gNB or combination thereof) management as a proxy for sensing signal measurement quality. For example, WTRU 302 may determine to report RLM measurements for sensing signal measurement quality. The RLM measurements may include CSI/SSB-RSRP or CSI/SSB-RSRQ on transmission configuration indicator (TCI) states that may be QCL or otherwise associated with the sensing measurement configured, or CSI-IM measurements made on NZP-CSI-RS resources configured by the parent gNB.

In certain representative embodiments, WTRU 302 may perform the sensing measurement configured by the wireless network and estimate the quality of the sensing measurement based on the quality measurement configured for the sensing measurement. If, for example, the quality measurement for the sensing measurement is above threshold conditions of the configured quality requirement to report to, e.g., the parent gNB, WTRU 302 may report the sensing measurement to the parent gNB. If, for example, the sensing measurement is above threshold conditions of the configured quality requirement to report to, e.g., the SF, WTRU 302 may report the sensing measurement to the SF. If, for example, the quality measurement for the sensing measurement does not meet any of the threshold conditions of the configured quality requirements WTRU 302 may indicate that the quality measurement was out of range for all configured sensing services and not report the sensing measurement.

In accordance with certain embodiments of the present disclosure, WTRU 302 sensing measurements of process 300 are described as follows.

WTRU 302 sensing measurement values may include, for example, a timing measurement value, a phase measurement value, an angular measurement value, a power measurement value, and/or a detection measurement value. The timing measurement value may include, for example, a delay of a received RS from interaction with a sensing target relative to reference (e.g., DL frame timing reference, direct path between STx and SRx, or any other suitable reference, or any combination thereof). The phase measurement value, may include, for example, a phase offset between a received RS interacting with a sensing target and a phase reference (e.g. phase of direct path RS received between STx and SRx). The angular measurement value, may include, for example, a measured angle of arrival of a received RS that has interacted with a target, relative to global navigation satellite system (GNSS) orientation. The power measurement value, may include, for example, a measured signal strength of a received RS that has interacted with a target, either in absolute terms or relative to a configured reference. The detection measurement may include, for example, a decision made on whether a received RS indicates the presence or lack of presence of a sensing target. By further example, sensing measurement values may include AoA, time of arrival (ToA), phase delay, or time difference of arrival (TDOA) between two different RS.

In some embodiments, process 300 steps 312-316 may be repeated, as represented by steps 318-322 and the following vertical ellipsis. For example, these steps may be repeated according to the configured periodicity of the sensing measurement and the configured periodicity of quality measurement (e.g., as configured in steps 308 and 310). As steps 318-322 are identical or substantially similar to steps 312-316, details here are omitted for brevity.

In some embodiments, steps 324-330 correspond to examples of the WTRU identifying one or more destinations (e.g., gNB 304 and SF 306), associated with one or more sensing services, to report each of the sensing measurement values based on the respective quality measurement value and reporting to said one or more destination. For example, at step 324, WTRU 302 may determine that the CSI-RSRP is below threshold quality and measurement latency is within requirement. Accordingly, WTRU 302 may, at step 326 report the timing measurement to gNB 304. In another example, at step 328, WTRU 302 may determine that CSI-RSRP is above threshold quality and measurement latency is not within requirement. Accordingly, WTRU 302 may, at step 330 report the timing measurement to SF 306.

In accordance with certain embodiments of the present disclosure, WTRU 302 identifying and reporting sensing measurement values to destinations of process 300 is described as follows.

In certain representative embodiments, WTRU 302 may report measurement values based on determination of a measurement reporting event associated with measurement quality conditions. For example, measurement quality conditions associated with measurement reporting event may include a WTRU measurement quality configuration and/or receiving an indication to trigger a reporting event. As an example, a WTRU may receive an indication of one or more measurement quality configurations (e.g., corresponding to step 310). In another example, a WTRU may determine that a timing measurement quality of a sensing measurement is above the link quality requirement and the associated CSI-RSRP is above the link quality requirement and, accordingly, the WTRU may report the sensing measurement to the SF.

In certain representative embodiments, WTRU 302 measurement report resource allocation may include, for example, measurement report format (e.g., a physical channel for reporting, PUSCH, PUCCH, or any other suitable measurement report format, or any combination thereof), rules for multiplexing measurement reports with additional UL control signaling and data (e.g., SR, ACK/NACK, or any other rule, or any combination thereof), measurement destination (e.g., parent gNB, SF, core network, or any other measurement destination, or any combination thereof), and/or reporting periodicity. For example, a reporting event of WTRU 302 may require WTRU 302 to transmit a single aperiodic transmission in the indicated resource. In another example, reporting event of WTRU 302 may require WTRU 302 to continue transmitting in a periodic resource for a fixed number of reports or until indicated to stop reporting.

In certain representative embodiments, WTRU 302 may receive an indication of one or multiple configured sensing measurement quantities to report when the reporting event is triggered. In certain representative embodiments, WTRU 302 may receive an indication to report the observed measurement quality that triggered the reporting event.

In some embodiments, WTRU 302 may be configured with multiple sensing conditions (e.g., quality measurement configurations) that each indicate a different reporting destination, to which the sensing WTRU 302 is communicatively connected, for sensing measurement reporting. For example, the quality measurement configuration may include one or more measurement quality conditions for reporting to gNB 304 and may include one or more measurement quality conditions for reporting to the core network (e.g., SF 306).

In events where WTRU 302 determines that the quality conditions are met for reporting to gNB 304, WTRU 302 reports sensing measurement values made by WTRU 302 to gNB 304. For example, if WTRU 302 determines that the CSI-RSRP measured by the WTRU 302 (e.g., in steps 316 and 322) meets the quality requirements configured for gNB 304, and WTRU 302 meets the latency requirements for reporting to gNB 304, WTRU 302 may determine to report CSI-RSRP to gNB 304.

In events where WTRU 302 determines that the quality conditions are met for reporting to SF 306, WTRU 302 reports sensing measurement values made by WTRU 302 to SF 306. For example, if WTRU 302 determines that the RSRP of RS measured by WTRU 302 above the configured threshold for SF 306, WTRU 302 may determine to report the RSRP to SF 306.

In events where WTRU 302 determines that both measurement quality conditions for gNB 304 and SF 306 are met WTRU 302 may proceed according to the following examples. For example, WTRU 302 may report sensing measurement values to both gNB 304 and SF 306. In another example, WTRU 302 may report sensing measurement values to gNB 304 with an indication that the measurement can also be forwarded to SF 306. As another example, WTRU 302 may report sensing measurement values according to a configured priority. For instance, WTRU 302 may be configured, by the wireless network, with a priority level for each gNB 304 and SF 306. If the priority level associated with gNB 304 is higher than that of the priority level associated with SF 306, WTRU 302 may determine to report the sensing measurement values to the gNB 304. WTRU 302 may use a high layer signaling associated with the wireless network entity the WTRU 302 reports to (e.g., RRC for the serving gNB, LPP for LMF, or any other high layer signaling, or any combination thereof). In another example, WTRU 302 may be configured to report sensing measurement values to either SF 306 or gNB 304. As another example, WTRU 302 may determine, based on the content of the measurement, to report to an entity (e.g., gNB 304, SF 306, or any other entity, or any combination thereof) associated with the measurement type. For instance, if the report contains measurement values related to interference, WTRU 302 may determine to report the measurement values to gNB 304. In another instance, if the report contains measurements made based on DL-RS for sensing, WTRU 302 may determine to report the measurement values to SF 306.

In events where WTRU 302 determines that no measurement quality conditions are satisfied, WTRU 302 may indicate to gNB 304 that measurement quality conditions are not met. For example, the indication of WTRU 302 may include a preferred reconfiguration of sensing measurement resources to improve sensing measurement quality.

In certain representative embodiments, WTRU 302 may be configured with maximum and minimum sensing quality thresholds. For example, WTRU 302 may determine that sensing measurement quality exceeds the maximum measurement quality condition threshold. Based on the determination, WTRU 302 may indicate to the reporting destination (e.g., gNB 304, SF 306, or any other reporting destination, or any combination thereof) that the sensing measurement is overprovisioned, and fewer sensing resources should be reserved. In another example, WTRU 302 may determine that the sensing measurement quality falls below minimum measurement quality threshold. Based on the determination, WTRU 302 may indicate to the reporting destination that the sensing measurement is under-provisioned and more sensing resources may need to be allocated for the sensing measurement. Further to this example, WTRU 302 may indicate preferred DL-RS configurations for sensing (e.g., preferred number of symbols for DL-RS, preferred number of slots for DL-RS, preferred periodicity for DL-RS, or any other configuration, or any combination thereof). In another example, when WTRU 302 determines that the measurement quality falls below the required measurement quality threshold, WTRU 302 may not report measurements and indicate to the wireless network that the measurement quality was not satisfied. In some embodiments, WTRU 302 may be configured with a maximum hysteresis for sensing measurement quality conditions. For example, X multiple consecutive measurement quality estimates must exceed the maximum quality threshold before WTRU 302 may indicate a preference to reduce resource allocation for a sensing measurement. In some embodiments, WTRU 302 may be configured with a separate minimum hysteresis for sensing measurement quality conditions. For example, Y multiple consecutive measurement quality estimates must fall below the minimum quality threshold before WTRU 302 may indicate a preference to increase resource allocation for a sensing measurement.

As a non-limiting example, it is contemplated that process 300 may be described as follows. WTRU 302 may be configured with a sensing measurement; for example, WTRU 302 may be configured to estimate the delay of an RS reflecting off a target relative to same RS transmitted directly from the sensing Tx to the sensing RX. WTRU 302 may be configured to measure the sensing quality for the configured sensing measurement; for example, WTRU 302 may be configured to estimate the range of delay estimates for the timing measurement that account for 95% of possible delay estimates for the given target. WTRU 302 may be configured to measure the sensing quality for the configured sensing measurement; for example, WTRU 302 may be configured to estimate the time duration after the measurement is completed for which the measured value may considered to be valid. WTRU 302 may be configured, by the wireless network, with a sensing quality requirement for low latency sensing where the sensing measurement is reported to gNB 304 (e.g., parent gNB) when the measurement report can be transmitted within the expected valid duration measurement configured for WTRU 302. WTRU 302 may be configured, by the wireless network, with a sensing quality requirement for high precision sensing where the sensing measurement is reported to SF 306 when the measurement report can be transmitted with 95% of possible delay estimates being within X nanoseconds of each other. WTRU 302 may perform the configured sensing measurements and the associated sensing quality measurements. WTRU 302 may estimate that the sensing measurement quality is sufficient for reporting low latency sensing, and, accordingly, WTRU 302 reports the delay measurement to gNB 304. WTRU may estimate that the sensing measurement quality is sufficient for reporting high precisions sensing, and, accordingly, the WTRU reports the delay measurement to SF 306.

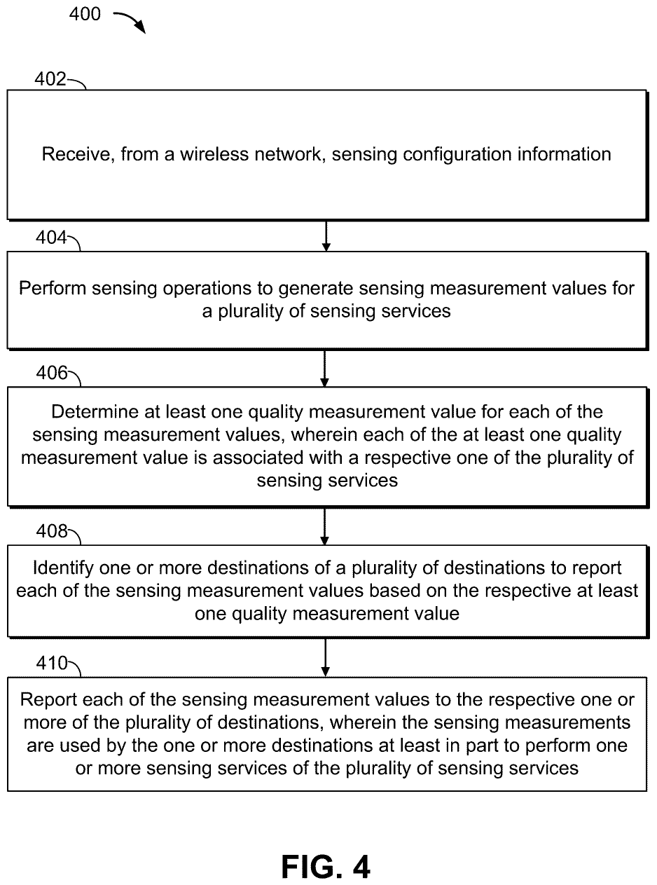

FIG. 4 is a flowchart of an illustrative method performed by a WTRU for reporting sensing measurement values based on WTRU quality measurements, in accordance with certain embodiments.

In certain representative embodiments, as shown in FIG. 4, a process 400 is performed by a WTRU (e.g., WTRU 102 of FIGS. 1A-1D, WTRUs 212-224 of FIG. 2, and WTRU 302 of FIG. 3) in connection with a wireless network (e.g., RAN 104 and 113 of FIGS. 1A-D and/or core network 106 and 115 of FIGS. 1A-1D), which may be implemented in communications system 100 illustrated in FIG. 1A-1D. In some embodiments, the wireless network may include and/or be associated with at least one of: sensing receivers; sensing transmitters; a RAN (e.g., RAN 104 and 113 of FIGS. 1A-1D); an AMF (e.g., AMF 182a and 182b of FIGS. 1A-1D); a sensing NF; an AF; combinations of the same; or the like.

At step 402 (e.g., steps 308 and 310 of FIG. 3), the WTRU receives, from a wireless network, sensing configuration information. In some embodiments, the WTRU receives sensing configuration information from a gNB and/or a core network of the wireless network (e.g., a SF). For example, the WTRU may receive a sensing measurement configuration from a gNB (e.g., step 308 of FIG. 3) and may receive a quality measurement configuration from a SF (e.g., step 310 of FIG. 3). For example, the sensing measurement configuration may include any one or more of a measurement type, a measurement quantity, and a measurement filtering configuration. For example, the quality measurement configuration may include any one or more of a quality measurement identifier, the sensing measurement identifier, a periodicity for determining the at least one quality measurement, a quality measurement type of the at least one quality measurement, or a quality measurement quantity for the at least one quality measurement.

In some embodiments, the sensing measurement configuration and quality measurement configuration are associated with one or more sensing services (e.g., asset tracking and localization, intruder detection, roadside monitoring, or any other sensing services, or any combination thereof.). The one or more sensing services may also be associated with a respective plurality of destinations. The WTRU may, thus, be configured to report sensing measurement values and quality measurement values of the sensing measurement values for one or more sensing services that may be associated with different reporting destinations.

At step 404 (e.g., step 316 of FIG. 3.) the WTRU performs sensing operations to generate sensing measurement values for a plurality of sensing services. For example, sensing measurement values may include any one or more of a timing measurement value, a phase measurement value, an angular measurement value, a power measurement value, and/or a detection measurement value. By further example, sensing measurement values may include AoA, time of arrival (ToA), phase delay, or time difference of arrival (TDOA) between two different RS. For example, sensing services may include roadside monitoring 201, geofencing and intrusion detection 203, and high precision asset tracking 205 of FIG. 2. These sensing service may be configured in different partially or completely overlapping regions (e.g., regions 206, 208, and 210 of FIG. 2) within the wireless network coverage area.

At step 406 (e.g., step 316 of FIG. 3.), the WTRU determines at least one quality measurement value for each of the sensing measurement values, wherein each of the at least one quality measurement value is associated with a respective one of the plurality of sensing services. In some embodiments, quality measurements may include implicit and/or explicit measurement types. For example, implicit quality measurements may include any one or more of using a signal quality value of the sensing measurement values as a proxy for the at least one quality measurement value, measuring interference, or using radio link quality metrics as a proxy for the at least one quality measurement value. For example, explicit quality measurement values may include any one or more of: a range of delay estimates from a timing measurement, a timing resolution for a timing measurement, a range of phase estimates from a phase measurement, a range of angle estimates from an angular measurement, a variance of measured power from an RS, an estimated probability of missed detection or false alarm from a detection measurement decision, a ratio of valid measurements to invalid measurements, or a time required to collect a valid quality measurement.

At step 408 (e.g., step 324 and step 328 of FIG. 3.), the WTRU identifies one or more destinations of a plurality of destinations to report each of the sensing measurement values based on the respective at least one quality measurement value. In some embodiments, the one or more destinations of the plurality of destinations includes a gNB of the wireless network and/or or a core network (e.g., SF) of the wireless network. The WTRU may, for example, identify one or more respective sensing services for each of the plurality of destinations, compare the respective at least one quality measurement value associated with each of the plurality of sensing services to respective threshold values, and based on the comparing, identifying the one or more destinations. For example, respective threshold values may be configured by each of the respective sensing services and/or for each respective destination. In another example, the at least one quality measurement value may serve as a trigger for a reporting event to the one or more destinations of a plurality of destinations. In some embodiments, for example, where the WTRU determines that the at least one quality measurement value meets only one threshold configuration, the WTRU may report to only the destination corresponding to the threshold configuration that is met. In some embodiments, for example, where the WTRU determines that the at least one quality measurement value meets more than one threshold configuration, the WTRU may report to all of the destinations corresponding the threshold configurations that are met or may have one or more configurations and/or rules to determine which destination receives the report.

At step 410 (e.g., step 316 of FIG. 3.), the WTRU reports each of the sensing measurement values to the respective one or more of the plurality of destinations, wherein the sensing measurement values are used by the one or more destinations at least in part to perform one or more sensing services of the plurality of sensing services.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶0 6 or means-plus-function claim format, and any claim without the terms “means for” is not so intended.

What is claimed is:

1. A method performed by a wireless transmit/receive unit (WTRU), the method comprising:
receiving, from a wireless network, sensing configuration information; and
based on the sensing configuration information:
performing sensing operations to generate sensing measurement values for a plurality of sensing services,
determining at least one quality measurement value for each of the sensing measurement values, wherein each of the at least one quality measurement value is associated with a respective one of the plurality of sensing services,
identifying one or more destinations of a plurality of destinations to report each of the sensing measurement values based on the respective at least one quality measurement value, and
reporting each of the sensing measurement values to the respective one or more of the plurality of destinations, wherein the sensing measurement values are used by the one or more destinations at least in part to perform one or more sensing services of the plurality of sensing services.

2. The method of claim 1, wherein the sensing configuration information comprises any one or more of: a sensing measurement identifier, identification of one or more time domain resources, identification of one or more frequency domain resources, a periodicity for generating the sensing measurement values, a reference signal (RS) configuration, or a sensing measurement configuration, wherein the sensing measurement configuration comprises a sensing measurement type.

3. The method of claim 2, wherein:
the sensing configuration information comprises a quality measurement configuration, and
the quality measurement configuration comprises any one or more of: a quality measurement identifier, the sensing measurement identifier, a periodicity for determining the at least one quality measurement value, a quality measurement type of the at least one quality measurement value, or a quality measurement quantity for the at least one quality measurement value.

4. The method of claim 1, wherein the sensing measurement values comprise any one or more of: a timing measurement value, a phase measurement value, an angular measurement value, a power measurement value, or a detection measurement value.

5. The method of claim 1, wherein the sensing measurement values comprise any one or more of: an angle of arrival, a time of arrival, a phase delay, or a time difference of arrival between two different RS.

6. The method of claim 1, wherein the at least one quality measurement value comprises at least one explicit quality measurement value, wherein the at least one explicit quality measurement value comprises any one or more of: a range of delay estimates from a timing measurement, a timing resolution for a timing measurement, a range of phase estimates from a phase measurement, a range of angle estimates from an angular measurement, a variance of measured power from an RS, an estimated probability of missed detection or false alarm from a detection measurement decision, a ratio of valid measurements to invalid measurements, or a time required to collect a valid quality measurement value.

7. The method of claim 1, wherein the at least one quality measurement value comprises at least one implicit quality measurement value, wherein the at least one implicit quality measurement value comprises any one or more of: using a signal quality value of the sensing measurement values as a proxy for the at least one quality measurement value, measuring interference, or using radio link quality metrics as a proxy for the at least one quality measurement value.

8. The method of claim 1, wherein each of the plurality of destinations is associated with a respective one or more sensing services of the plurality of sensing services.

9. The method of claim 8, wherein the identifying the one or more destinations comprises:
identifying the one or more respective sensing services for each of the plurality of destinations;
comparing the respective at least one quality measurement value associated with each of the plurality of sensing services to respective threshold values; and
based on the comparing, identifying the one or more destinations.

10. The method of claim 1, wherein the one or more destinations of the plurality of destinations comprises at least one of a gNB of the wireless network or a core network of the wireless network.

11. A wireless transmit/receive unit (WTRU) in communication with a wireless network, the WTRU comprising:
a processor; and
a transceiver coupled to the processor, wherein the WTRU is configured to:
receive, from a wireless network, sensing configuration information; and based on the sensing configuration information:
perform sensing operations to generate sensing measurement values for a plurality of sensing services,
determine at least one quality measurement value for each of the sensing measurement values, wherein each of the at least one quality measurement value is associated with a respective one of the plurality of sensing services,
identify one or more destinations of a plurality of destinations to report each of the sensing measurement values based on the respective at least one quality measurement value, and
report each of the sensing measurement values to the respective one or more of the plurality of destinations, wherein the sensing measurement values are used by the one or more destinations at least in part to perform one or more sensing services of the plurality of sensing services.

12. The WTRU of claim 11, wherein the sensing configuration information comprises any one or more of: a sensing measurement identifier, identification of one or more time domain resources, identification of one or more frequency domain resources, a periodicity for generating the sensing measurement values, a reference signal (RS) configuration, or a sensing measurement configuration, wherein the sensing measurement configuration comprises a sensing measurement type.

13. The WTRU of claim 12, wherein:
the sensing configuration information comprises a quality measurement configuration, and
the quality measurement configuration comprises any one or more of: a quality measurement identifier, the sensing measurement identifier, a periodicity for determining the at least one quality measurement value, a quality measurement type of the at least one quality measurement value, or a quality measurement quantity for the at least one quality measurement value.

14. The WTRU of claim 11, wherein the sensing measurement values comprise any one or more of: a timing measurement value, a phase measurement value, an angular measurement value, a power measurement value, or a detection measurement value.

15. The WTRU of claim 11, wherein the sensing measurement values comprise any one or more of: an angle of arrival, a time of arrival, a phase delay, or a time difference of arrival between two different RS.

16. The WTRU of claim 11, wherein the at least one quality measurement value comprises at least one explicit quality measurement value, wherein the at least one explicit quality measurement value comprises any one or more of: a range of delay estimates from a timing measurement, a timing resolution for a timing measurement, a range of phase estimates from a phase measurement, a range of angle estimates from an angular measurement, a variance of measured power from an RS, an estimated probability of missed detection or false alarm from a detection measurement decision, a ratio of valid measurements to invalid measurements, or a time required to collect a valid quality measurement value.

17. The WTRU of claim 11, wherein the at least one quality measurement value comprises at least one implicit quality measurement value, wherein the at least one implicit quality measurement value comprises any one or more of: using a signal quality value of the sensing measurement values as a proxy for the at least one quality measurement value, measuring interference, or using radio link quality metrics as a proxy for the at least one quality measurement value.

18. The WTRU of claim 11, wherein each of the plurality of destinations is associated with a respective one or more sensing services of the plurality of sensing services.

19. The WTRU of claim 18, wherein the WTRU configured to identify the one or more destinations is further configured to:
identify the one or more respective sensing services for each of the plurality of destinations;
compare the respective at least one quality measurement value associated with each of the plurality of sensing services to respective threshold values; and
based on the comparing, identify the one or more destinations.

20. The WTRU of claim 11, wherein the one or more destinations of the plurality of destinations comprises at least one of a gNB of the wireless network or a core network of the wireless network.
